(19) United States
(12) Patent Application Publication
(10) Pub. No.: US 2025/0278806 A1
(43) Pub. Date: Sep. 4, 2025

(54) Jerusalem Redemption

(71) Applicant: Vladislav Nikolic, Chicago, IL (US)

(72) Inventor: Vladislav Nikolic, Chicago, IL (US)

(21) Appl. No.: 18/593,943

(22) Filed: Mar. 3, 2024

(51) Int. Cl. G06Q 50/26; G06Q 50/18

(52) U.S. Cl. CPC G06Q 50/26; G06Q 50/188

(57) ABSTRACT

The Jerusalem Redemption is a universal humane, spiritual, religious, metaphysical and existentially unique conflict solution modeled method through the use of protocolary conferences meetings, written correspondence and mutually reached consensus about how unreconcilable people and countries of the world, particularly Israeli and Palestinian official spiritual, religious and metaphysical leaders' unreconcilable spiritual, religious and metaphysical doctrines of co-existential and co-habitational territorial and statehood conflicts can be patently solved.

### CROSS-REFERENCE TO RELATED APPLICATIONS

### Not Applicable.

### STATEMENT REGARDING FEDERALLY SPONSORED RESEARCH OR DEVELOPMENT

### Not Applicable.

### THE NAMES OF THE PARTIES TO A JOINT RESEARCH AGREEMENT

### Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

### Not Applicable.

### STATEMENT REGARDING PRIOR DISCLOSERS BY THE INVENTOR OR A JOINT INVENTOR

### Not Applicable.

### BACKGROUND OF THE INVENTION

Observing over time the Israeli and Palestinian state governments' unreconcilable co-existential and co-habitational territorial and statehood conflicts, Inventor became curious and, on or about November 2019, began to consider and jot down a concept about which peaceful and reciprocal modeled method could be invented to patently solve such seemingly unreconcilable conflicts between these two neighboring states.
Here is Inventor's developed concept about this Jerusalem Redemption's modeled method and its correspondences' protocol.

### BRIEF SUMMARY OF INVENTION

In his best faith and intention, Inventor donates this modeled method in gratis to the Jewish and Palestinian people alike¹ to demonstrate to them by prescribing and claiming the precise procedural process and correspondences' protocol how to peacefully and reciprocally among and between themselves solve their decades-long co-existential and co-habitational territorial and statehood unreconcilable conflicts. ¹ With respectful acknowledgement to both the Jewish and Palestinian people, future references in the text will be in alphabetical order.
The Jerusalem Redemption prioritizes and addresses exclusively the Jewish and Palestinian people and their official spiritual, religious and metaphysical leaders, and not their previous or current political, governmental or representative authority figures.
This invention is not a political, governmental or arbitrary approach for any conflict resolution whatsoever. The Jerusalem Redemption is exclusively and ultimately a universal spiritual, religious and metaphysical modeled method's clarifying solution for unreconcilable conflicts between and among individuals, peoples, countries and their governments of the world. The Jerusalem Redemption shall be equally applied, implemented and utilized exclusively by Jewish and Palestinian peoples' official spiritual, religious and metaphysical leaders for their mutual sake toward universal truth, justice, peace, well-being and prosperity for both Jewish and Palestinian peoples.
The fact is that Israel's and Palestine's previous and current state governments and authority figures are continuing to protract decades-long unresolved co-existential and co-habitational state territories and statehood conflicts between and among Jewish and Palestinian people. Those authoritarian figures have escalated this unreconcilable conflict to unprecedented genocidal proportions of the unbearable loss of human lives with unimaginable human suffering and catastrophic disasters for Jewish and Palestinian people in Israel and Palestine.
Numerous arbitrary attempts, undertakings and approaches, that had been proposed, organized and conducted by the world's leading states and their governments' representatives, have not yielded any feasible, let alone lasting, conflict resolution. The urgency for Jerusalem Redemption's universal spiritual, religious and metaphysical modeled method's patented solution for Jewish and Palestinian people is desperately needed, and a hoped-for reciprocal, peaceful and just co-existence and co-habitation is existentially more vital than ever.
Considering that the Jewish and Palestinian people and their spiritual, religious and metaphysical official leaders are more good-willing and collaborative between and among themselves and each other than not, after decades of their undeserved mutual suffering, the Jewish and Palestinian people in particular have, and now more than ever, had enough of the arrogant, current unprecedented capricious government representatives who stubbornly maintain and protract their inhumane geopolitical policies of hate and warmongering. These strategies have escalated and continue to escalate the decades-long conflict even into the first two decades of the 21^{st} century toward unprecedented genocidal proportions, with the utmost suffering and disasters for Jews and Palestinians. Such an Armageddon-like course of action ultimately leads to the destruction of any chance for the peaceful co-existence and co-habitation between Jewish and Palestinian people.
Inventor, in his own best faith and intention, due to the urgency of the spiritual and existential survival of the Jewish and Palestinian people, appeals to Jewish and Palestinian people's official spiritual, religious and metaphysical leaders to consider applying, implementing and utilizing the Jerusalem Redemption's modeled patent's solution and its correspondences' protocol, even as the last hope that which such unique undertakings would become, at least, a hopeful expectation of how an unimaginable reward and cathartic release would be felt upon Jewish and Palestinian people, and the world as a whole, if the Jerusalem Redemption became successful as it is invented to be.
Otherwise, inventor would not have thought, considered, conceived, wrote or donated the Jerusalem Redemption in gratis to Jewish and Palestinian people if he were uncertain about its effectiveness and ultimate success.

### BRIEF DESCRIPTION OF THE SEVERAL VIEWS OF THE DRAWING(S)

### Not Applicable.

### SPECIFICATION

For the Jerusalem Redemption's modeled method to be effective as a patented conflict solution, the first and foremost important precondition is that under no circumstances shall this invention include the involvement and intermingling of any foreign countries' political and state authorities, including Israeli and Palestinian current political figure(s) and government authorities, or any other third-party sources.

The Jerusalem Redemption shall be utilized exclusively by the Jewish people's official spiritual, religious and metaphysical leaders, and by the Palestinian people's official spiritual, religious and metaphysical leaders, reciprocally.

The key factors for the Jerusalem Redemption model to be properly and effectively applied, implemented and ultimately successful are the Jewish Spiritual, Religious and Metaphysical Leaders' and the Palestinian Spiritual, Religious and Metaphysical Leaders' special, indispensable and essential roles, especially in influencing, particularly, the Jewish and Palestinian people's individual and collective beliefs, ethics and personal behaviors toward each other, toward their decades-long and contemporaneous co-existential and co-habitational territorial and statehood irreconcilable conflicts, and toward the world in general; thus the Jewish Spiritual, Religious and Metaphysical Leaders and the Palestinian Spiritual, Religious and Metaphysical Leaders are collectively termed as Jerusalem Redemption's Benefactors.

The Jerusalem Redemption's Benefactors shall organize and commence separate, simultaneous and respective meetings on the same date and time, exclusively in the city of Jerusalem, designated as the Jerusalem Redemptions' Conference Meetings. The Jewish Spiritual, Religious and Metaphysical Leaders shall organize, commence and meet in the western part of the city of Jerusalem. The Palestinian Spiritual, Religious and Metaphysical Leaders shall organize, commence and meet in the eastern part of city of Jerusalem. The Jerusalem Redemptions' Conference Meetings' time limit shall be a maximum of three consecutive days (72 hours) without breaking days in between.

The Jerusalem Redemptions' Conference Meetings will be closed to the public, media, government and any other third party source before or during the Jerusalem Redemptions' Conference Meetings for as long as necessary, until a final draft of mutual and reciprocal Jerusalem Redemption's Declarations statements establish a consensus between the Jewish Spiritual, Religious and Metaphysical Leaders and the Palestinian Spiritual, Religious and Metaphysical Leaders.

Communication between the Jewish Spiritual, Religious and Metaphysical Leaders and the Palestinian Spiritual, Religious and Metaphysical Leaders shall be conducted exclusively by written correspondences. No verbal or any other mode of communication (except for officially written correspondences) shall be permitted between the Jewish Spiritual, Religious and Metaphysical Leaders and the Palestinian Spiritual, Religious and Metaphysical Leaders before or during the Jerusalem Redemptions' Conference Meetings for as long as necessary until a final draft of mutual and reciprocal Jerusalem Redemption's Declarations statements establish a consensus between the Jewish Spiritual, Religious and Metaphysical Leaders and the Palestinian Spiritual, Religious and Metaphysical Leaders. Once a consensus has been reached, and the Jerusalem Redemption's Declarations statements have been signed, it shall be publicly announced at the same date and time, and promulgated exclusively and only by the Jewish Spiritual, Religious and Metaphysical Leaders to Jewish people in Israel, and by the Palestinian Spiritual, Religious and Metaphysical Leaders to Palestinian people in Palestine.

At the Jerusalem Redemptions' Conference Meetings the Jerusalem Redemption's Benefactors shall reciprocally sign their Jerusalem Redemption's Declarations statements. The preamble of the Jerusalem Redemption's Declarations shall include the Jewish Spiritual, Religious and Metaphysical Leaders' and Palestinian Spiritual, Religious and Metaphysical Leaders' specific spiritual, religious and metaphysical domains. In the preamble, the Jewish Spiritual, Religious and Metaphysical Leaders and Palestinian Spiritual, Religious and Metaphysical Leaders shall acknowledge that they are trained and educated, and that they have professional, spiritual, religious and metaphysical knowledge, authorization, ethical responsibility and obligation to and for their Jewish and Palestinian people's spiritual, religious and metaphysical well-being; and accordingly, teach, conduct, guide and lead them toward peaceful, civil, law abiding and moral virtues in their co-existence and co-habitation, and to cease supporting and promoting hatred, accusation, blame, bloodshed and aggressive, destructive, and offensive doctrines against each other in whatever name or for whatever cause such doctrines may be contemplated and conceived, as it is simply a reprehensible and inhumane practice by any spiritual, religious or metaphysical means and standards.

The essential and main context and purpose of the Jerusalem Redemption's Declarations statements are the Jewish Spiritual, Religious and Metaphysical Leaders' collective transgressions and infringements placed upon the Palestinian Spiritual, Religious and Metaphysical Leaders and Palestinian people; and vice versa, the Palestinian Spiritual, Religious and Metaphysical Leaders' collective transgressions and infringements placed upon the Jewish Spiritual, Religious and Metaphysical Leaders and Jewish people.

The collective transgressions and infringements shall be written consciously, truthfully, clearly, concisely and without justification or reason why those transgressions and infringements have been committed by the Jewish Spiritual, Religious and Metaphysical Leaders, and by the Palestinian Spiritual, Religious and Metaphysical Leaders, respectively.

The collective transgressions and infringements of the Jewish Spiritual, Religious and Metaphysical Leaders and the Palestinian Spiritual, Religious and Metaphysical Leaders shall be enumerated under numerals, being the length of no more than one paragraph with a maximum of 150 words, unless the transgressions and infringements are lengthier in substance and meaning.

After each enumerated transgression and infringement has been written and enumerated in the Jerusalem Redemption's Declarations, the Jewish Spiritual, Religious and Metaphysical Leaders and Palestinian Spiritual, Religious and Metaphysical Leaders shall consciously, truthfully, clearly, concisely and without justification or reason why those enumerated redemptions proposals have been proposed write their collective redemption proposals concerning what or which concrete redemption actions or deeds they propose in their best faith, and pledge their proposed redemptions to redeem the enumerated transgressions and infringements satisfactorily and reciprocally toward each other (i.e., the Jewish Spiritual, Religious and Metaphysical Leaders toward the Palestinian Spiritual, Religious and Metaphysical Leaders, and vice versa, the Palestinian Spiritual, Religious and Metaphysical Leaders toward the Jewish Spiritual, Religious and Metaphysical Leaders), with each collective redemption proposal being the length of no more than one paragraph with a maximum of 150 words, unless a redemption proposal is lengthier in substance and meaning.

After the Jerusalem Redemption's Declarations have been completed with the proper preambles and main context and purpose, and the final drafts have been fully signed by all Jewish Spiritual, Religious and Metaphysical Leaders and Palestinian Spiritual, Religious and Metaphysical Leaders respectively, the Jewish Spiritual, Religious and Metaphysical Leaders and Palestinian Spiritual, Religious and Metaphysical Leaders shall, through their official emissaries, send and reciprocally hand-deliver their Jerusalem Redemption's Declarations with redemptions' proposals at the same date and time to each other for analysis, consideration and response(s) to establish, and in particular for the first time in their modern history, an official correspondence between each other. With that procedural process they will open the door to a unique opportunity, which had been for decades almost impossible to imagine, that the Jewish Spiritual, Religious and Metaphysical Leaders along with the Palestinian Spiritual, Religious and Metaphysical Leaders, colleges and scholars will and can reconcile and redeem their decades-long, and current, irresoluble opposing spiritual, religious and metaphysical denominational doctrines. Their correspondence shall be documented, recognized and archived exclusively under the official term of Jerusalem Redemptions' Redeemed Communications.

And, as a final phase of the Jerusalem Redemption modeled method's patented conflict solution, the Jewish Spiritual, Religious and Metaphysical Leaders and Palestinian Spiritual, Religious and Metaphysical Leaders, for their Jewish and Palestinian people respectively, shall make an in gratis version of this Jerusalem Redemption and teach by elucidating the Jerusalem Redemption's first and foremost undisputable redemption rule, which states and stipulates that the Jewish and Palestinian people shall look, search and find first their spiritual, religious, metaphysical and physical truth for themselves by themselves—following the example of their spiritual, religious and metaphysical leaders with their newly and exemplary established Jerusalem Redemptions' Redeemed Communications—about what they have done wrong to others by doing, or wronged others by not doing; particularly and specifically, what the Jewish people have done by doing wrong, or wronged by not doing, to the Palestinian people, without justification or reason why those transgressions and infringements have been committed and without mentioning what the Palestinian people have done by doing wrong, or wronged by not doing, to the Jewish people; and vice versa, particularly and specifically, what the Palestinian people have done by doing wrong, or wronged by not doing, to the Jewish people, without justification or reason why those transgressions and infringements have been committed and without mentioning what the Jewish people have done by doing wrong, or wronged by not doing, to the Palestinian people. Consequently, this invention's patently modeled method and its protocols if utilized, applied and implemented reciprocally by Jerusalem Redemption's Benefactors and by Jewish and Palestinian peoples will truthfully, universally and equitably solve their decades-long seemingly unreconcilable co-existential and co-habitational territorial and statehood conflicts for their uniquely redeemed and lasting peaceful co-existence, co-habitation and sovereign statehoods.

What I claim as my invention is a method comprising:

1. Meeting: A meeting, by the collective of the Jerusalem Redemption's Benefactors comprising the Jewish Spiritual, Religious and Metaphysical Leaders and the Palestinian Spiritual, Religious and Metaphysical Leaders, shall be separately organized each in the city of Jerusalem to be conducted at the same date and time;
a. the Jewish Spiritual, Religious and Metaphysical Leaders shall meet in the west part of the city of Jerusalem;
b. the Palestinian Spiritual, Religious and Metaphysical Leaders shall meet in the east part of the city of Jerusalem;
c. the meetings shall have a time limit not to exceed three (3) consecutive days or a total of seventy-two (72) hours;
d. the meetings shall be conducted without any “off day(s)” in between the time limits; and
e. the meeting will be closed to a public, media, political and governmental authorities, or for anyone not of the Jewish Spiritual, Religious and Metaphysical Leaders or the Palestinian Spiritual, Religious and Metaphysical Leaders.

2. Draft Proposal and Establish Written Communication: A separate redemption proposal shall each be contemplated, discussed, and written by the Jewish Spiritual, Religious and Metaphysical Leaders and the Palestinian Spiritual, Religious and Metaphysical Leaders, respectively, expressing their individual Jewish Spiritual, Religious and Metaphysical Leaders' and Palestinian Spiritual, Religious and Metaphysical Leaders' redemption declarations;
a. said redemption proposal of the redemption declarations comprises the Jewish Spiritual, Religious and Metaphysical Leaders' collective transgressions and infringements placed upon the Palestinian Spiritual, Religious and Metaphysical Leaders and Palestinian people; and vice versa, the Palestinian Spiritual, Religious and Metaphysical Leaders' collective transgressions and infringements placed upon the Jewish Spiritual, Religious and Metaphysical Leaders and Jewish people;
b. the collective transgressions and infringements shall be written clearly, concisely and without justification or reason why said transgressions and infringements have been committed by the Jewish Spiritual, Religious and Metaphysical Leaders, and by the Palestinian Spiritual, Religious and Metaphysical Leaders, respectively;
c. the collective transgressions and infringements shall be enumerated under numerals, with each enumerated redemption declaration being the length of one paragraph with a maximum of 150 words, unless the transgressions and infringements are lengthier in substance and meaning;
d. for each enumerated collective transgression and infringement the Jewish Spiritual, Religious and Metaphysical Leaders and Palestinian Spiritual, Religious and Metaphysical Leaders shall consciously, truthfully, clearly, concisely and without justification or reason why those enumerated redemption proposals have been proposed write their collective redemption proposals concerning what or which concrete redemption actions or deeds they propose in their best faith, and pledge their proposed redemptions to redeem the enumerated transgressions and infringements satisfactorily and reciprocally toward each other (i.e., the Jewish Spiritual, Religious and Metaphysical Leaders toward the Palestinian Spiritual, Religious and Metaphysical Leaders, and vice versa, the Palestinian Spiritual, Religious and Metaphysical Leaders toward the Jewish Spiritual, Religious and Metaphysical Leaders), with each collective redemption proposal being the length of no more than one paragraph with a maximum of 150 words, unless a redemption proposal is lengthier in substance and meaning;
e. the redemption declarations are to be collected, sorted, tabulated and organized by the Jewish Spiritual, Religious and Metaphysical Leaders and the Palestinian Spiritual, Religious and Metaphysical Leaders, respectively; and
f. the Jewish Spiritual, Religious and Metaphysical Leaders and the Palestinian Spiritual, Religious and Metaphysical Leaders shall each write the completed final draft of redemption declarations, and each sign their respective final draft.

3. Share Proposal to Redeem and Sign: On the fourth day after commencement of the meeting, at 9:00 am local Jerusalem time, the Jewish Spiritual, Religious and Metaphysical Leaders and the Palestinian Spiritual, Religious and Metaphysical Leaders shall, at the same time, send their official emissaries to hand-deliver their respective Jerusalem Redemption's Declarations with redemptions' proposals to each other for analysis, consideration and response(s);
a. until a final consensus has been reached between the Jewish Spiritual, Religious and Metaphysical Leaders and Palestinian Spiritual, Religious and Metaphysical Leaders of their redemption proposals, officially signed and publicized, no verbal, personal, direct, live meetings or otherwise, except for the official Jerusalem Redemptions' Redeemed Communications correspondence between the Jewish Spiritual, Religious and Metaphysical Leaders and Palestinian Spiritual, Religious and Metaphysical Leaders, shall be permitted or accepted, and all Jerusalem Redemptions' Redeemed Communications correspondence shall be, as prima fascia, reciprocally protected by Israeli and Palestinian intellectual property and patent laws and regulations, as if under signed confidentiality and non-disclosure and non-circumvention agreements between the Jewish Spiritual, Religious and Metaphysical Leaders and the Palestinian Spiritual, Religious and Metaphysical Leaders;
b. the Jerusalem Redemptions' Redeemed Communications shall comprise preambles with the Jewish Spiritual, Religious and Metaphysical Leaders' and the Palestinian Spiritual, Religious and Metaphysical Leaders' stated expertise in their spiritual, religious and metaphysical domains, and its main context being the enumerated redemptions proposals; and
c. available options for how to respond to the enumerated redemption proposals are: agree, disagree and seek amendment; if the seek amendment option is selected, the Jewish Spiritual, Religious and Metaphysical Leaders and Palestinian Spiritual, Religious and Metaphysical Leaders shall unambiguously and clearly write what and how the specific enumerated redemption proposal(s) needs to be, and shall be amended; and this amendment(s) shall be notarized by the Jewish Spiritual, Religious and Metaphysical Leaders and by the Palestinian Spiritual, Religious and Metaphysical Leaders respectively, and officially documented and archived in the Jerusalem Redemptions' Redeemed Communications.

4. Agreement Reaches Solution: After a consensus between the Jewish Spiritual, Religious and Metaphysical Leaders' and the Palestinian Spiritual, Religious and Metaphysical Leaders' redemption proposals has been reached, and a reciprocal and mutually agreed upon written form, has been officially signed, it shall be on the same date and time authentically, without any post changes or redactions, publicized, by the Jewish Spiritual, Religious and Metaphysical Leaders and by the Palestinian Spiritual, Religious and Metaphysical Leaders respectively to the Jewish and Palestinian people, promulgated and verified as a historic document officially documented and archived under the term and title as the Jerusalem Redemption's Patented Solution.
